(19) United States
(12) Patent Application Publication
(10) Pub. No.: US 2007/0234599 A1
(43) Pub. Date: Oct. 11, 2007

(54) Display Frames

(76) Inventor: Alan Blain DAVIS, Reno, NV (US)

Correspondence Address: RISSMAN JOBSE HENDRICKS & OLIVERIO, LLP, ONE STATE STREET, SUITE 800, BOSTON, MA, 02109, US

(21) Appl. No.: 11/685,197

(22) Filed: Mar. 12, 2007

Related U.S. Application Data
(60) Provisional application No. 60/781,946, filed on Mar. 10, 2006.

(51) Int. Cl. G09F 3/02

(52) U.S. Cl. 40/27.5

(57) ABSTRACT

A display system may include a support member having a first side and a second side, and at least one three-dimensional compartment in the support member. The second side faces a direction opposite to the first side. Each of the compartments is open at the first side of the support member and closed at the second side of the support member. The contents of each compartment are visible from the second side of the support member. Each compartment is configured to receive an object.

### CROSS-REFERENCE TO RELATED APPLICATIONS

This application claims the benefit of priority of U.S. provisional application No. 60/781,946, filed on Mar. 10, 2006, the contents of which are incorporated herein by reference in their entirety.

### TECHNICAL FIELD

The present disclosure relates to display frames. More particularly, the disclosure is directed to wall-mountable display frames for displaying complete sets of collectible items that have been accrued by a consumer.

### BACKGROUND

Currently, most industries selling collectible items do not offer display platforms for a “complete set” of their products, nor do they offer a display platform that preserves and protects the valuable properties of the products. This is especially true of the collectible coin industry.

In the case of conventional collectible coin display platforms, the coins displayed are those that have been “in circulation”, i.e., the coins are found in loose change. Thus, the openings or compartments in such conventional containers are sized to match a coin, rather than to match a display case that contains a coin or coins. Moreover, the displayed coinage housed in these other display platforms is not in “gem brilliant, uncirculated” or “US Proof” condition.

There may be a desire to provide the owners of incremental collectible items with a suitable platform to showcase the complete contents of their collections. This is especially true for consumers who actively pursue the collection of special coinage and products marketed by the collectible coin marketing industry and wish to display all the incremental items within their collections.

### SUMMARY OF THE INVENTION

The Universal Display System platform is to provide the consumer with an apparatus that will allow them to showcase their collectible items that normally represent a strong sense of pride in addition to what is usually a significant investment.

This invention includes a support member and a plurality of compartments on the second side of the support member for inserting sealed and intact collectible coin display cases. Thus, the Universal Display System may provide added value by preserving and protecting the integrity of the “gem brilliant, uncirculated” condition of the coins.

### BRIEF DESCRIPTION OF THE DRAWINGS

The disclosed subject matter of the present application will now be described in more detail with reference to exemplary embodiments of the apparatus, given only by way of example, and with reference to the accompanying drawings, in which:

FIG. 1 is a front perspective view of a display frame in accordance with various aspects of the disclosure;

FIG. 2 is a rear plan view of the display frame of FIG. 1;

FIG. 3 is a cross-sectional view along line III-III of FIG. 2;

FIG. 4 is a front perspective view of an exemplary display system including the display frame of FIG. 1;

FIG. 5 is a front perspective view of an alternative display frame in accordance with various aspects of the disclosure;

FIG. 6 is a front perspective view of another alternative display frame in accordance with various aspects of the disclosure; and

FIG. 7 is a front perspective view of yet another alternative display frame in accordance with various aspects of the disclosure.

### DETAILED DESCRIPTION

Referring to the drawing figures, like reference numerals designate identical or corresponding elements throughout the several figures.

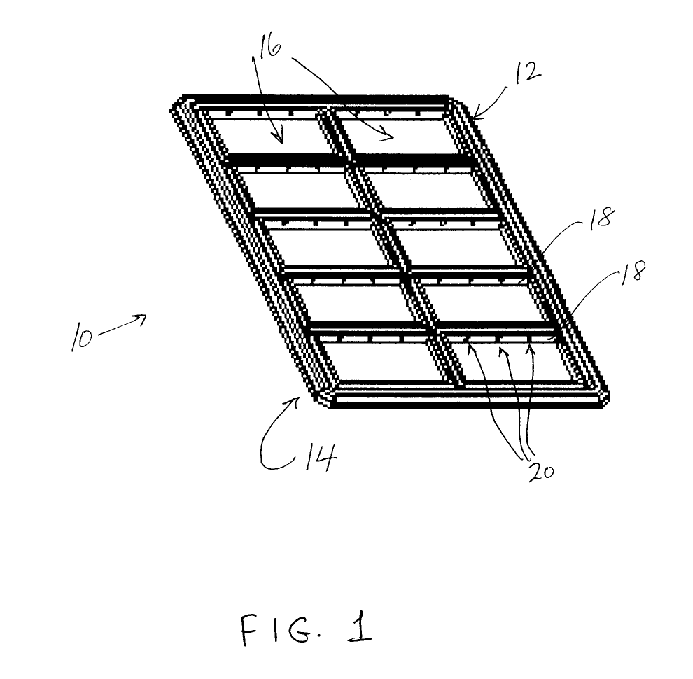

Referring now in detail to the drawings, an exemplary display frame 10 consistent with this disclosure may comprise a number of interrelated elements as shown in FIGS. 1-4. According to some aspects, the display frame 10 may be made of plastic, wood, metal or a combination of two or more of the aforementioned materials.

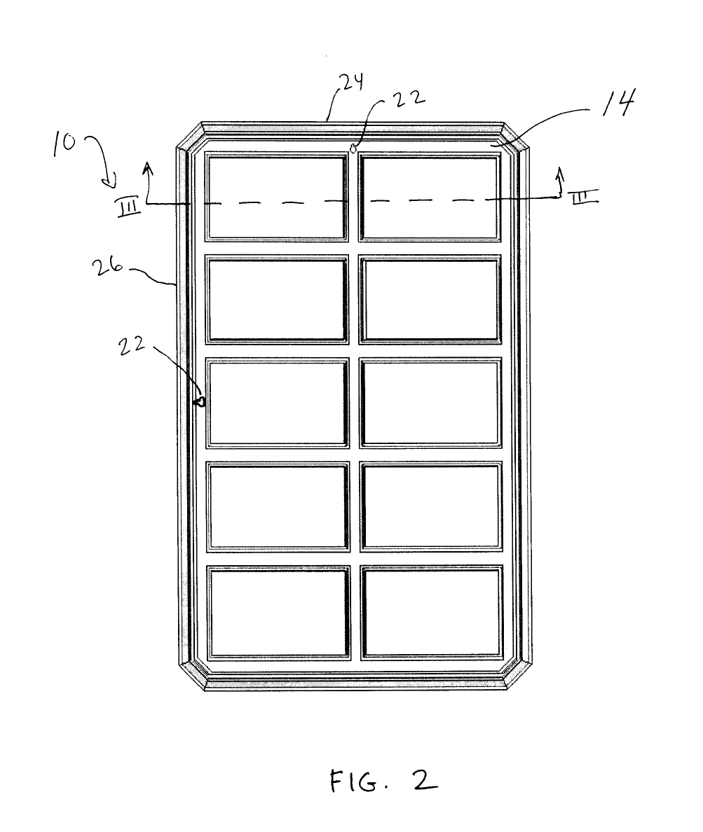

As shown in FIG. 1, the exemplary frame 10 may comprise a first side 12 (i.e., a front side) and a second side 14 (i.e., a rear side—FIG. 2). The frame 10 may include a plurality of compartments, or openings, 16 delimited by at least one wall 18. Each compartment 16 may be open at the first and second sides 12, 14. According to some aspects, the compartments 16 may have four walls 18 defining a shape such as, for example, a square, rectangular, diamond, or the like. It should be appreciated that the compartments 16 may be delimited by any number of walls defining any known shape.

According to various aspects of the disclosure, one or more of the walls 18 may include one or more raised projections 20. The projections 20 may be formed of a material that is deformable, crushable, or the like. For example, the projections 20 may be constructed of plastic, wood, or the like.

Referring now to FIG. 2, according to various exemplary aspects, the display frame 10 may include one or more sockets 22 at the second, or rear, side 14 configured to facilitate wall mounting of the display frame 10. For example, the sockets 22 may be sized and arranged to receive a picture-hanging hook, the head of a nail or screw, or the like. In some aspects, the wall mounting socket 22 may be centered and spaced from one of the side edges 24, 26 of the display frame 10. For example, in some aspects, the socket 22 may be approximately 1 inch from the respective side edge 24, 26 of the frame. This may facilitate the easy mounting of the display on a wall by the consumer in either a vertical or horizontal orientation.

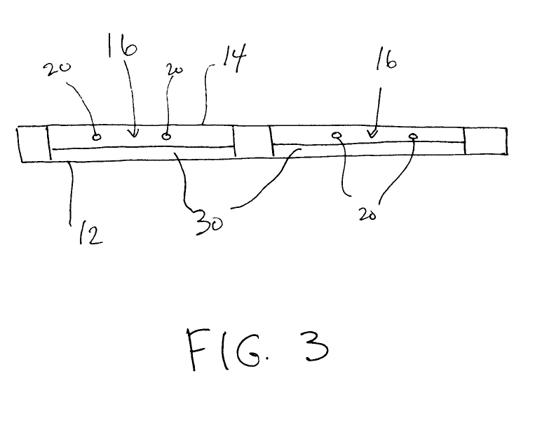

As shown in FIG. 3, each compartment 16 may be further delimited by at least one framing member 30 extending from a side wall 18 of the compartment 16. The framing member 30 may extend substantially perpendicular to the side wall 18 and substantially parallel to the first and second side 12, 14.

For example, in some aspects, the compartment 16 may be delimited by four side walls 18, and each side wall 18 may have a framing member 30 extending therefrom. The framing member 30 prevent an object in the compartment from falling out or being urged out the first, or front, side 12 of the frame 10. To remove an object from the compartment 16, a user can urge the object from the first side 12 out the second, or rear, side 14 of the frame 10.

According to some aspects of the disclosure, the display frame 10 may comprise a clear acrylic or lexan polycarbonate display lens (not shown) that is attached, for example, via bonding, to the first side 14 of the display frame 10. The lens permits viewing of the contents of the compartments of the frame 10 from the first side 14.

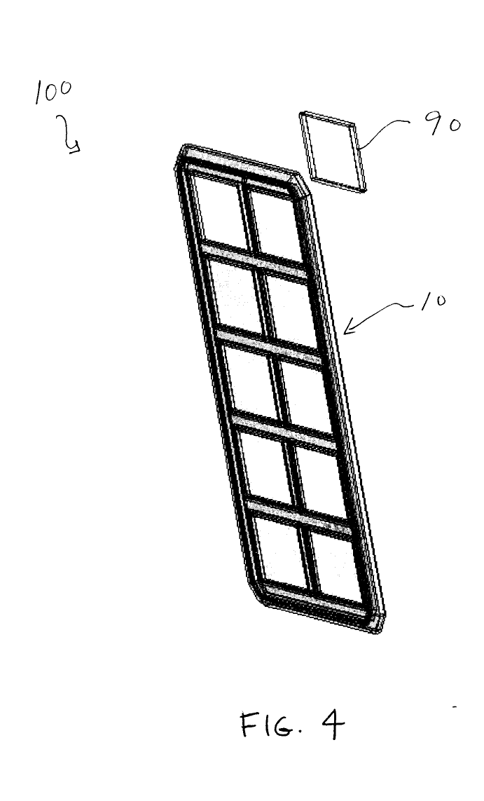

Referring now to FIG. 4, according to various aspects, one or more consumer-supplied small collectible item display cases 90 may be received by the plurality of openings or compartments 16 at the rear side 14 of the display frame 10. For example, the dimensions of the openings or compartments on the rear side of the base (width, height, and depth) may be substantially the same size as the display cases commonly used in the collectible coin industry. FIG. 4 illustrates the exemplary frame 10 and an exemplary display case 90 utilized by the collectible coin industry to house each year's increment of the Quartermania State Quarter Collection (i.e., the five state quarters minted that year). It is noteworthy that the Quartermania coins are sold in “gem brilliant, uncirculated” condition, thus the sample display case shown is sealed to protect and preserve these valuable properties.

The dimensions of the ten compartments may be specifically chosen to match the dimensions of the small display cases commonly used in the collectible coin industry. For example, the currently marketed “Quartermania” state quarter product features ten separate, annually issued, sealed display cases with each case holding the five state quarters minted in that calendar year. As noted, these ten display cases may fit perfectly into the display frame, providing the consumer with a wall mountable mechanism for displaying all ten incremental years of their valuable collection.

According to one exemplary aspect, the display frame 10 may be approximately 22 inches tall, about 14.4 inches wide, and approximately ¾″ thick. The display frame 10 may feature ten (10) compartments that will be placed in two vertical columns of five compartments each. Each of these compartments may measure 5.655″ wide, 3.475″ high, and have a depth of 0.325″. In addition, each of the ten compartments in the display frame may have four (4) projections, or “crush ribs,” two on each of a pair of opposed side walls, which will be used to hold the consumer inserted collectible item display cases in place in the compartments 16 of the display frame 10. Once each display case is inserted, the four crush ribs will compress thereby providing a friction fit to hold the display case securely in place. FIG. 4 is a complete, unobstructed view of a display system 100. As configured and depicted, it is set to house all the display cases that would form a complete ten year set of the Quartermania state quarter collection.

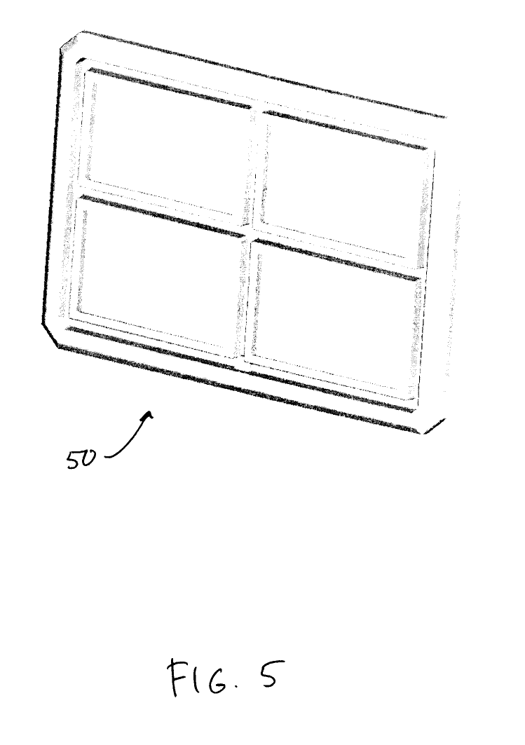

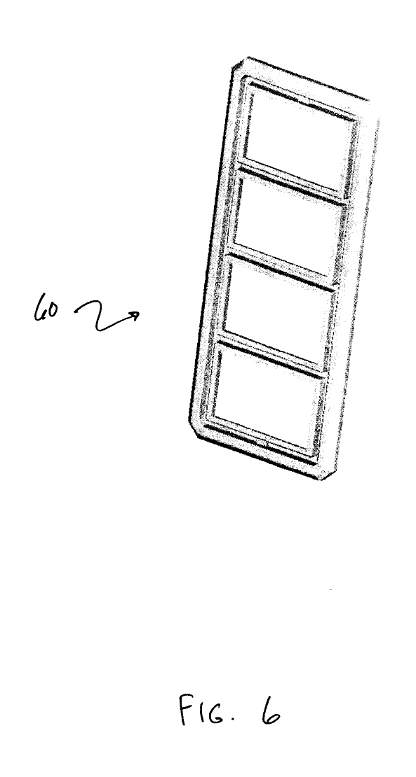

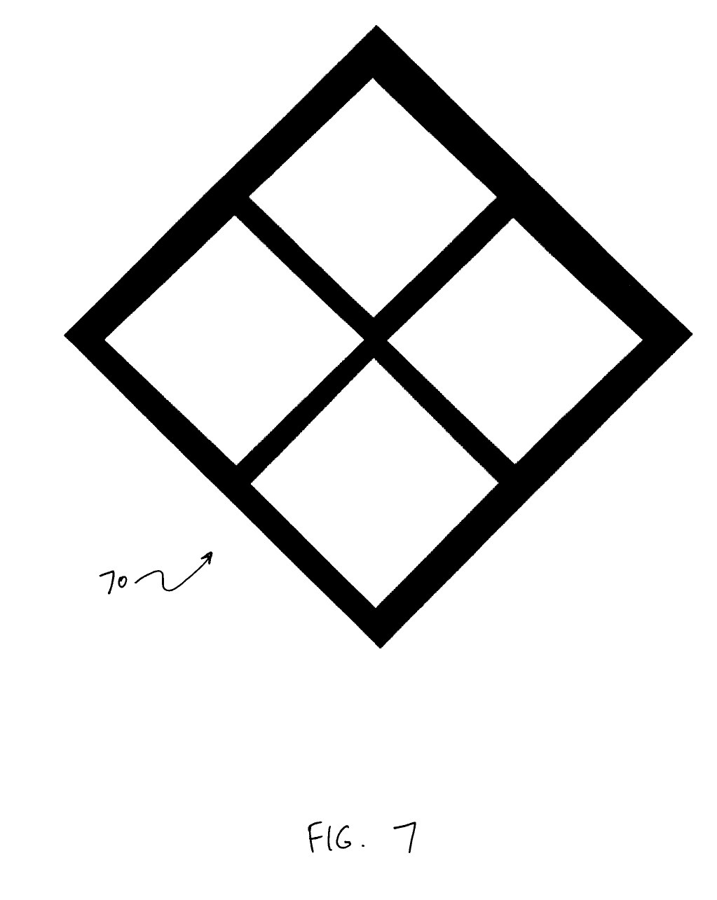

It should be appreciated that display frames consistent with the disclosure may include more than or less than the ten compartments shown in the FIGS. 1-4. For example, as shown in FIGS. 5-7, a display frame 50, 60, 70 may have four compartments. The compartments may be arranged a two-by-two rectangular configuration (FIG. 5), a column (or row) of four (FIG. 6), or in a diamond configuration (FIG. 7).

According to an exemplary embodiment, the display frame 50, 60, 70 may be configured to accommodate the U.S. Presidential Dollar Collectible Coin Series. The frames 50, 60, 70 contain four compartments—one for each of the four coins that the U.S. Mint plans to produce each year. The frames 50, 60, 70 may comprise raised projections, sockets, and framing members similar to those discussed above in connection with FIGS. 1-4.

It should also be appreciated that the aforementioned dimensions are exemplary only, and that the dimensions may be modified to accommodate cases of any size and/or shape. Moreover, it should be appreciated that the arrangement of the openings may be different than illustrated in the accompanying drawings. It should also be appreciated that the display system described in this disclosure may receive and display cases containing other types of collective and/or non-collective items such as, for example, stamps, trading cards, golf balls or tees, baseballs, or the like.

The display frames 10, 50, 60, 70 in accordance with the disclosure are novel apparatuses that may provide the collectors of various items of an incremental nature the capability of displaying all the items in their collection in one wall mounted display platform. Typically, these incremental items, which collectively make up a “complete” collection, are purchased and received by the consumer in clear plastic display cases. These collectible items, as distributed in their original display cases, are often perfectly sized for insertion into the plurality of openings or compartments provided for in the display frames.

According to some aspects of the invention, the display frames may serve as a wall-mountable base through which the consumer can view multiple collectible item display cases. The rear side of the base may serve as a support for a plurality of openings or compartments for the insertion of the consumer supplied collectible item display cases.

The display frames of the disclosure may provide the consumer with an apparatus that will allow them to showcase their collectible items which normally represent a strong sense of pride in addition to what is usually a significant investment. This invention, if properly utilized by the collector's of valuable coins, may provide added value by also preserving and protecting the integrity of the “gem brilliant, uncirculated” condition of their coins.

According to one exemplary embodiment, this disclosure may be especially suited to facilitate the needs of the collectors of the U.S. State Quarters “Quartermania” product, which, in total, encompasses ten separate display cases which will fit perfectly into the ten compartments illustrated in FIGS. 1-4. According to other embodiments, the disclosure may be especially suited to facilitate the needs of the collectors of the U.S. Presidential Dollar Collectible Coin Series, which has begin minting in February 2007 and encompasses four separate display cases per year which will fit perfectly into the four compartments illustrated in FIGS. 5-7.

It will be apparent to those skilled in the art that various modifications and variations can be made in the display frames of the present invention without departing from the scope of the invention. Other embodiments of the invention will be apparent to those skilled in the art from consideration of the specification and practice of the invention disclosed herein. It is intended that the specification and examples be considered as exemplary only.

What is claimed:

1. A display system, comprising:
a support member having a first side and a second side, the second side facing in a direction opposite to the first side; and
at least one three-dimensional compartment in the support member, each of said at least one compartment being delimited by at least one side wall and being open at the first and second sides of the support member, the contents of each compartment being visible from the second side of the support member, each compartment being configured to receive an object.

2. The display system of claim 1, wherein each said compartment has a depth dimension configured to receive an object containing a coin.

3. A display system, comprising:
a support member having a first side and a second side, the second side facing in a direction opposite to the first side; and
a three-dimensional compartment in the support member, said compartment being delimited by at least one side wall and being open at the first and second sides of the support member, the contents of the compartment being visible from the second side of the support member, the compartment being configured to receive an object.

4. The display system of claim 3, wherein said compartment has a depth dimension configured to receive an object containing a coin.

5. A display system, comprising:
a support member having a first side and a second side, the second side facing in a direction opposite to the first side; and
a plurality of three-dimensional compartments in the support member, each of said at least one compartment being delimited by at least one side wall and being open at the first and second sides of the support member, the contents of each compartment being visible from the second side of the support member, each compartment being configured to receive an object.

6. The display system of claim 5, wherein said compartments have a depth dimension configured to receive an object containing a coin.

7. The display system of claim 5, wherein each of said compartments has substantially the same three-dimensional size and shape.
